(19) United States
(12) Patent Application Publication
(10) Pub. No.: US 2007/0222716 A1
(43) Pub. Date: Sep. 27, 2007

(54) Source driver and driving method for display

(76) Inventors: Jiunn-Yau Huang, Hsinhua (TW); Cheng-Chi Yen, Tainan Science-Based Industrial Park (TW)

Correspondence Address: J.C. Patents, Inc., Suite 250, 4 Venture, Irvine, CA, 92618, US

(21) Appl. No.: 11/490,558

(22) Filed: Jul. 20, 2006

(30) Foreign Application Priority Data
Mar. 27, 2006 (TW) 95110500

(51) Int. Cl. G09G 3/30

(52) U.S. Cl. 345/76

(57) ABSTRACT

A source driver and driving method for display are provided. The source driver of the present invention comprising a plurality of current-driving units, each of which outputs a data current according to a display data for driving a light-emitting device. Each of the current-driving units comprises a plurality of current source circuits and a current mirror. According to the display data, at least one of the current source circuits is selectively activated to provide a current. The current mirror outputs the data current by mirroring the summation of the currents provided by the activated current source circuit(s).

### CROSS-REFERENCE TO RELATED APPLICATION

This application claims the priority benefit of Taiwan application serial no. 95110500, filed on Mar. 27, 2006. All disclosure of the Taiwan application is incorporated herein by reference.

### BACKGROUND OF THE INVENTION

1. Field of the Invention

The present invention relates to a source driver, and more particularly, to a source driver not affected by any voltage drop resulting from resistance at the anode of an organic light-emitting diode.

2. Description of Related Art

Organic light-emitting diode (OLED), also referred to as an organic electro-luminescent display (OELD), is a self light-emitting device. Because of the low DC voltage driven, high luminosity, high efficiency, high contrast ratio and light weight characteristics of an OLED and the capacity for emitting various colors ranging from the three primary colors of red, green and blue to white, OLED has been regarded as one of the most promising planar display panels of the next generation.

Aside from lightness and high resolution comparable to a liquid crystal display (LCD) and active emission, fast response and energy-efficient cold light source comparable to a light-emitting diode (LED), other advantages of the OLED include wide viewing angle, effective color contrast and low production cost. Therefore, OLED are commonly used as the back light for LCD or indicator panels or in mobile phones, digital cameras and personal digital assistants (PDA).

According to the driving mode, OLED can be classified as passive matrix driven light-emitting diode (PMOLED) or active matrix driven light-emitting diode (AMOLED). It should be noted that the OLED portion of both the AMOLED and the PMOLED are identical. The only difference lies in the circuit design of the OLED substrate.

The circuit architecture for driving the PMOLED is relatively simple. All that requires is to deposit a layer of organic light-emitting thin film at the perpendicular crossover junction between the transparent anode (ITO) and metal cathode. The pixels are turned on and lit up in sequence by scanning so that only one scan line of the gate driver is lit at one time. This implies that each light point must operate at a relatively high voltage if the display requires a definite average brightness level. In the AMOLED, thin film transistor (TFT) switches and driving circuits are added to each organic light-emitting diode pixel. Through the TFT switches and driving circuits, the continuous current flowing in the light-emitting diode is adjusted.

In a conventional PMOLED, different data currents are output through the source lines of the source driver for driving the OLED device so that different gray scales are produced to achieve a full coloration. However, the data current output from the source driver of a conventional PMOLED is frequently affected by the ITO voltage drop of the OLED, which leads to non-uniformity of the OLED display brightness level.

### SUMMARY OF THE INVENTION

Accordingly, at least one objective of the present invention is to provide a source driver, a display and a method of driving a display panel that utilize a two-stage current mirror to provide a data current for driving an organic light-emitting diode so as to eliminate the effects caused by anode resistance of the organic light-emitting diode.

To achieve these and other advantages and in accordance with the purpose of the invention, as embodied and broadly described herein, the invention provides a source driver comprising a plurality of current-driving units. According to a display data, each of the current-driving units outputs a data current to drive the light-emitting device. Each of the current-driving units also comprises a plurality of current source circuits and a current mirror. According to the display data, at least one of the current source circuits is selectivity activated to provide a current. The current mirror outputs the data current by mirroring the summation of the currents provided by the activated current source circuit(s).

From another perspective, the present invention also provides a display that having a gate driver, a source driver and a display panel. The gate driver is outputting scan signals through a plurality of gate lines. The source driver comprises a plurality of current-driving units, each of which outputs a data current through a source line according to a display data for driving the light-emitting device. Furthermore, each of the current-driving units comprises a plurality of current source circuits and a current mirror. According to the display data, at least one of the current source circuits is selectivity activated to provide a current. The current mirror outputs the data current by mirroring the summation of the currents provided by the activated current source circuit(s). The display panel has a plurality of light-emitting devices. Each of the light-emitting devices is coupled to one of the corresponding source lines and one of the corresponding gate lines.

In one embodiment of the present invention, the anode and the cathode of each of the light-emitting devices are respectively coupled to the source lines and gate lines, or the anode and cathode of each of the light-emitting devices are respectively coupled to the gate lines and source lines.

In one embodiment of the present invention, the display is a passive organic electro-luminescent display (OELD).

In the above mentioned embodiment of the present invention, in each of the current-driving units, at least one of the current source circuits is constantly activated. In addition, the foregoing each of the current-driving units, each of the currents provided by the selectively activated current source circuits is a multiple of that provided by the constantly activated current source circuit, wherein the multiple is 2ⁿ, where n is a natural number.

In the above mentioned embodiment of the present invention, the current mirror comprises a first transistor and a second transistor. A first source/drain terminal of the first transistor receives a first voltage, and a second source/drain terminal and a gate terminal of the first transistor terminal are commonly coupled to the current source circuits. A first source/drain terminal of the second transistor receives the first voltage, and a gate terminal of the second transistor is coupled to the gate of the first transistor, and a second source/drain terminal of the second transistor outputs the data current.

In the above mentioned embodiment of the present invention, each of the current source circuits comprises a current source and a switch. The current source provides one of the currents. One end of the switch is coupled to the current source and the other end of the switch is coupled to receive a second voltage, and being controlled by a signal generated according to the display data.

In the above mentioned embodiment of the present invention, the first voltage is a system voltage and the second voltage is a ground voltage, and the first transistor and the second transistor are P-type transistors. In the other embodiment of the present invention, the first voltage is a ground voltage and the second voltage is a system voltage, and the first transistor and the second transistor are N-type transistors.

From another point of view, the present invention also provides a driving method for a display panel. The display panel has an array of light-emitting devices. The driving method comprising the follow steps: first, providing a plurality of current source circuits. After receiving a display data and a scan signal, selectively activating the current source circuits to generate a plurality of currents according to the display data, and then outputting a data current by mirroring a summation of the currents generated by the activated current source circuits. Finally, according to the data current, driving each of the light-emitting devices which enabled by the scan signal.

In one embodiment of the present invention, for any two of the currents generated by the current source circuit, wherein the larger one is 2ⁿ times of the smaller one, where n is a natural number.

In the above mentioned embodiment of the present invention, the light-emitting device is an organic light-emitting diode or a light-emitting diode.

The source driver of the present invention utilizes a two-stage current mirror to provide a data current for driving an organic light-emitting diode. Through this two-stage current mirror, the effects caused by anode resistance of the organic light-emitting diode can be eliminated so that the brightness of the organic electro-luminescent display is more uniform and stable.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a display according to one embodiment of the present invention.

FIG. 2 is a circuit diagram of a current-driving unit of the source driver according to one embodiment of the present invention.

FIG. 3 is a flowchart showing the driving method of a display panel according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention aims to resolve the problem of non-uniform picture frames appearing on an organic electro-luminescent display due to the significant voltage drop in the anode of the organic light emitting diode in the conventional technique. Thus, the present invention provides a source driver, a display and a driving method of a display panel for resolving the foregoing problem.

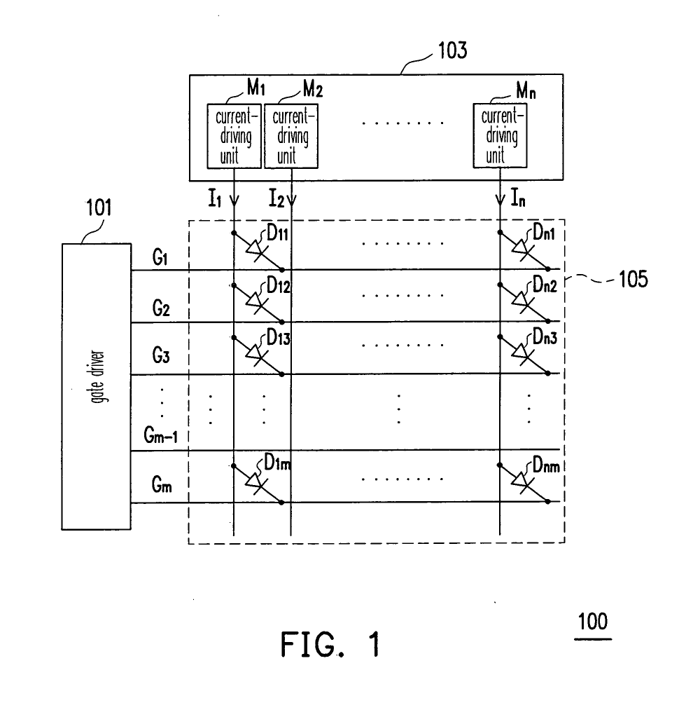

FIG. 1 is a block diagram of a display according to one embodiment of the present invention. As shown in FIG. 1, the display 100 includes a gate driver 101, a source driver 103 and a display panel 105. The gate driver 102 has a plurality of gate lines G1˜Gm for outputting scan signals Vscan to the gate lines G1˜Gm. The source driver 103 includes a plurality of current-driving units M1˜Mn for receiving display data and outputting data currents Id1˜Idn to the corresponding source lines I1˜In.

The display panel 105 is coupled to the gate driver 101 and the source driver 103. The display panel 105 has a plurality of light-emitting devices (they can be organic light-emitting diodes or light-emitting diodes) D11˜Dnm. Each of the light-emitting devices D11˜Dnm is coupled to one of the corresponding gate lines G1˜Gm and one of the corresponding source lines I1˜In. Each of the source lines I1˜In is coupled to the anodes of one of the light-emitting diodes D11˜Dnm and each of the gate lines G1˜Gm is coupled to the cathodes of one of the light-emitting diodes D11˜Dnm.

In the present embodiment, the display 100 may be a passive organic electro-luminescent display (POELD).

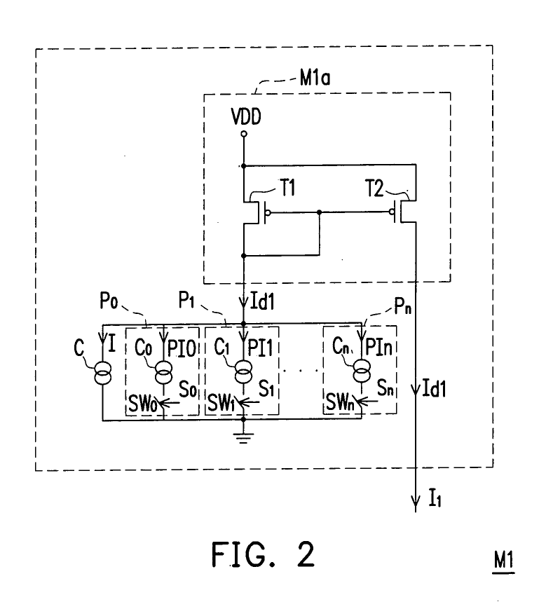

FIG. 2 is a circuit diagram of a current-driving unit M1 of the source driver 103 according to one embodiment of the present invention. As shown in FIGS. 1 and 2, the current-driving unit M1 includes a current source C, a plurality of current source circuits P0˜Pn and a current mirror M1a. The current source C is constantly activated to provides a current I. The current source circuits P0˜Pn are selectively activated ditto generate a plurality of currents PI0˜PIn according to the display data. Each of the current source circuits P0˜Pn includes a current source C0, C1, . . . or Cn, and switches SW0, SW1, . . . or SWn. The current source C0, C1, . . . , or Cn provides the current PI0, PI1, . . . or PIn. Each of the currents PI0˜PIn is 2ˆn times of the current I (that is, 2ˆn*I, where n is a natural number) generated by the current source C.

Each of the switches SW0˜SWn has one end coupled between the current source C0, C1, . . . , Cn and the other end coupled to receive a ground voltage. The switches SW0˜SWn are controlled by the signals S0˜Sn representing bits of the display data. In an alternative embodiment of the present invention, the switches SW0˜SWn may be coupled between the current sources C0˜Cn and the source of the transistor T1.

The current mirror M1a includes the P-type transistors T1 and T2. The drain of the transistor T1 is coupled to the drain of the transistor T2 and the system voltage VDD. The gate and the source of the transistor T1 are commonly coupled to the current source circuits P0˜Pn. The gate of the transistor T2 is coupled to the gate of the transistor T1 and the source of the transistor T2 is coupled to the source line I1.

In the present embodiment, the circuit configurations of the current-driving units M2˜Mn of the source driver 103 are similar to the current driving unit M1 so that a detailed description thereof is not provided.

When the source driver 103 receives the display data, the signals S0˜Sn determines the on/off state of the switches SW0˜SWn. Each of the current source circuits having the switches closed by the signals S0, S1, . . . , or Sn is activated to generate the currents PI0, PI1, . . . , or PIn. The current mirror M1a of the current-driving unit M1 outputs a data current Id1 to the source line I1 by mirroring the currents provided by the activated current source circuits. The data current Id1 is a summation of the currents provided by the activated current source circuits.

For example, when the data current Id1 required by the display data is five times the current I, the switches SW0 and the switch SW2 must be closed so that the current sources C0 and C2 provide currents to the current mirror M1a. Therefore, by accumulating the current of the current source C0 (equal to the current I) and the current of the current source C2 (four times of the current I), a total current equal to 5 times of the current I is obtained.

Similarly, the source driver 103 transforms the display data to data currents Id2˜Idn through the current-driving units M2˜Mn respectively. Afterwards, the data currents Id2˜Idn are mirrored to the corresponding source lines I2˜In through the current mirrors M2a˜Mna of the current-driving units M2˜Mn.

Next, the mirrored currents are output to the corresponding source lines I1˜In. Together with the scan signals Vscan (low-enable signals) output from the gate lines G1˜Gm of the gate driver 101, the light-emitting devices D11˜Dnm enabled by the signals Vscan are driven by the data currents Id1˜Idn.

Alternatively, the source lines I1˜In of the source driver 103 may be coupled with the cathodes of the light-emitting devices D11˜Dnm, and the gate lines G1˜Gm may be coupled with the anodes of the light-emitting devices D11˜Dnm. In such a configuration, the transistors T1 and T2 in each of current-driving units are changed from P-type to N-type transistors, and their drains are coupled to the ground voltage. The switches SW0˜SWn of the current-driving units M1˜Mn are coupled to receive the system voltage Vdd, rather than the ground voltage.

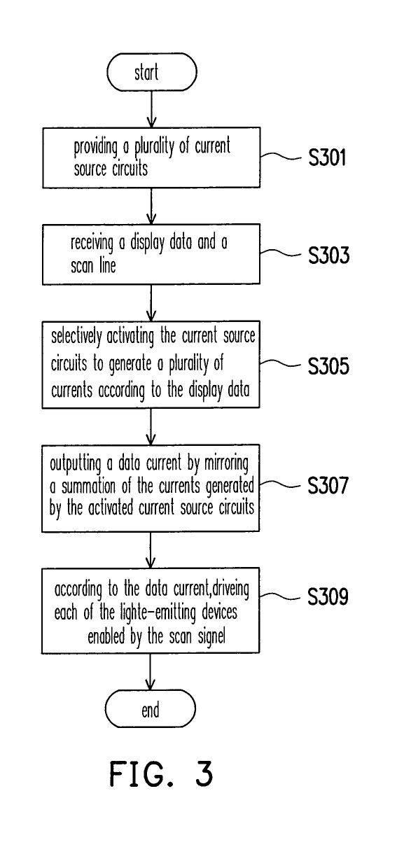

FIG. 3 is a flow diagram showing the driving method of a display panel according to one embodiment of the present invention. A plurality of light-emitting devices (organic light-emitting diodes or light-emitting diodes) arranged into an array is disposed inside the display panel. First, in step S301, a plurality of current source circuits are provided. Then, in step S303, a display data and scan signals are received. After that, in step S305, the current source circuits are selectively activated to generate currents according to the display data. For any two of the currents, the larger one is 2ⁿ times of the smaller one, where n is a natural number. Next, in step S307, a data current is output by mirroring a summation of the currents generated by the activated current source circuits. Finally, in step S309, each of the light-emitting devices enabled by the scan signals is driven by the data current.

In summary, the source driver in the present invention includes a two-stage current mirror to generate a data current. Hence, the source driver is unaffected by the voltage drop in the anode of the organic light-emitting diode so that the picture on an organic electro-luminescent display is more uniform and stable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver comprising:
a plurality of current-driving units, each of which outputs a data current according to a display data for driving a light-emitting device and each of the current-driving units comprises:
a plurality of current source circuits, at least one of which is selectively activated to provide a current according to the display data; and
a current mirror outputting the data current by mirroring the summation of the currents provided by the activated current source circuit(s).

2. The source driver of claim 1, wherein, in each of the current-driving units, at least one of the current source circuits is constantly activated.

3. The source driver of claim 2, wherein, in each of the current-driving units, each of the currents provided by the selectively activated current source circuits is a multiple of that provided by the constantly activated current source circuit.

4. The source driver of claim 3, wherein the multiple is 2ⁿ, where n is a natural number.

5. The source driver of claim 1, wherein the current mirror comprises:
a first transistor having a first source/drain terminal receiving a first voltage, and a second source/drain terminal and a gate terminal commonly coupled to the current source circuits; and
a second transistor having a first source/drain terminal receiving the first voltage, a gate terminal coupled to the gate of the first transistor and a second source/drain terminal outputting the data current.

6. The source driver of claim 5, wherein each of the current source circuits comprises:
a current source providing one of the currents; and
a switch having one end coupled to the current source and the other end coupled to receive a second voltage, and being controlled by a signal generated according to the display data.

7. The source driver of claim 6, wherein the first voltage is a system voltage, and the second voltage is a ground voltage, and the first transistor and the second transistor are P-type transistors.

8. The source driver of claim 6, wherein the first voltage is a ground voltage, the second voltage is a system voltage, and the first transistor and the second transistor are N-type transistors.

9. The source driver of claim 1, wherein the light-emitting device is an organic light-emitting diode or a light-emitting diode.

10. A display, comprising:
a gate driver outputting scan signals through a plurality of gate lines;
a source driver comprising a plurality of current-driving units, each of which outputs a data current through a source line according to a display data for driving a light-emitting device and each of the current-driving units comprises:
a plurality of current source circuits, at least one of which is selectively activated to provide a current according to the display data; and
a current mirror outputting the data current by mirroring the summation of the currents provided by the activated current source circuit(s); and
a display panel having a plurality of light-emitting devices each of which is coupled to one of the corresponding source lines and one of the corresponding gate lines.

11. The display of claim 10, wherein the anode and the cathode of each of the light-emitting devices are respectively coupled to the source and gate lines, or the anode and the cathode of each of the light-emitting devices are respectively coupled to the gate and source lines.

12. The display of claim 10, wherein, in each of the current-driving units, at least one of the current source circuits is constantly activated.

13. The display of claim 12, wherein, in each of the current-driving units, each of the currents provided by the selectively activated current source circuits is a multiple of that provided by the constantly activated current source circuit.

14. The display of claim 13, wherein the multiple is 2ⁿ, where n is a natural number.

15. The display of claim 10, wherein the current mirror comprises:
a first transistor having a first source/drain terminal receiving a first voltage, and a second source/drain terminal and a gate terminal commonly coupled to each of the current source circuits; and
a second transistor having a first source/drain terminal receiving the first voltage, a gate terminal coupled to the gate of the first transistor and a second source/drain terminal outputting the data current.

16. The display of claim 15, wherein each of the current source circuits comprises:
a current source providing one of the currents; and
a switch having one end coupled to the current source and the other end coupled to receive a second voltage, and being controlled by a signal generated according to the display data.

17. The display of claim 16, wherein the first voltage is a system voltage, the second voltage is a ground voltage, and the first transistor and the second transistor are P-type transistors.

18. The display of claim 16, wherein the first voltage is a ground voltage, the second voltage is a system voltage, and the first transistor and the second transistor are N-type transistors.

19. The display of claim 10, wherein the light-emitting device is an organic light-emitting diode or a light-emitting diode.

20. The display of claim 10, wherein the display is a passive organic electro-luminescent display.

21. A driving method for a display panel having an array of light-emitting devices, the method comprising the steps of:
providing a plurality of current source circuits;
receiving a display data and a scan signal;
selectively activating the current source circuits to generate a plurality of currents according to the display data;
outputting a data current by mirroring a summation of the currents generated by the activated current source circuits, and
according to the data current, driving each of the light-emitting devices enabled by the scan signal.

22. The driving method of claim 21, wherein, for any two of the currents generated by the current source circuit, the larger one is 2ⁿ times of the smaller one, where n is a natural number.

23. The driving method of claim 21, wherein the light-emitting devices is an organic light-emitting diode or light-emitting diode.
